(19) United States
(12) Patent Application Publication
(10) Pub. No.: US 2003/0161988 A1
(43) Pub. Date: Aug. 28, 2003

(54) High density optical disk

(75) Inventors: In-oh Hwang, Gyeonggi-do (KR); In-sik Park, Gyeonggi-do (KR); Kyung-geun Lee, Gyeonggi-do (KR)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD., Suwon-city (KR)

(21) Appl. No.: 10/202,610

(22) Filed: Jul. 25, 2002

(30) Foreign Application Priority Data
Feb. 2, 2002 (KR) 2002-6055

(51) Int. Cl. B32B 3/02

(52) U.S. Cl. 428/64.4

(57) ABSTRACT

A high density optical disk including a multi-layer film having at least one recording layer and a light transmission layer deposited on a substrate, with information capable of being recorded/reproduced by a light beam input from an upper portion of the light transmission layer, where a composition of the recording layer is Gex-sby-Tez, and has a composition ratio of 3≦x≦8, 65≦y≦80 and x+y+z=100. Thus, the wavelength of a laser diode adopted in an pickup becomes shorter and, as the NA of an objective lens becomes high, each layer forming a multi-layer film has a range of the thickness and composition ratio to satisfy an optical feature suitable therefore.

### CROSS-REFERENCE TO RELATED APPLICATIONS

This application claims the benefit of Korean Application No. 2002-6055, filed Feb. 2, 2002 in the Korean Industrial Property Office, the disclosure of which is incorporated herein by reference

### BACKGROUND OF THE INVENTION

1. Field of the Invention

The present invention relates to a high density optical disk having a multi-layer film structure, and more particularly, to a high density optical disk having a predetermined composition ratio of a recording layer and a predetermined thickness range of a multi-layer film to obtain a superior information recording/reproducing structure.

2. Description of the Related Art

In general, optical disks have become widely used as information recording media for use in optical pickup devices that record/reproduce information in a non-contact manner. The optical disks can be classified into compact discs (CDs) and digital versatile disks (DVDs) according to the capacity of recording information and their respective optical feature standards. The optical disks can be further classified into read only disks and re-writable disks. In the read only disks, there are CD-ROMs (read only memory) and DVD-ROMs. In the re-writable disks, there are CD-Rs, CD-RWs, CD-RAMs (random access memory), DVD-RWs, and DVD-RAMs.

A CD is typically 1.2 mm thick, formed of polycarbonate (PC), and reproduced by a laser diode having a 780 nm wavelength. The CD has a 1.6 μm pitch and a recording capacity of 650 MB on a single side, with an outer diameter of 120 mm. The DVD is formed by combining a polycarbonate reinforcement plate having a thickness of 0.6 mm on a substrate having a thickness of 0.6 mm, so as to be compatible with CD drives.

A phase change recording layer is used as a method for recording, erasing, and reproducing information with respect to the above disks. In the disk including the phase change recording layer, a crystalline material thereon is irradiated by a laser beam and turned into an amorphous state so that information can be read by the difference in reflectivity between the amorphous material and the crystalline material. For example, a recording layer formed by adding a third material to an Sb-Te eutectic composition is deposited on a substrate having a thickness of 0.6-1.2 mm. Such a disk is disclosed in U.S. Pat. No. 6,004,646 and U.S. Pat. No. 6,294,310.

In U.S. Pat. No.6,004,646, as illustrated in FIG. 1, a phase change disk includes a substrate 101, a lower dielectric layer 102, a recording layer 103, an upper dielectric layer 104, a reflective layer 105, and a protective layer 106. The recording layer 103 has a composition ratio of M_{w}(Sb_{z}Te_{1-z})_{1-w}. Here, 0≦w≦0.2 and 0.5≦z≦0.9, M is a material selected from a group consisting of Ga, Zn, Ge, Sn, Si, Cu, Au, Ag, Pd, Pt, Pb, Cr, Co, O, N, S, Se, Ta, Nb, V, Bi, Zr, Ti, Mn, Mo, and Rh. A thickness of the reflective layer 105 is within a range of 40-300 nm, with a thickness of the recording layer 103 being within a range of 10-30 nm and a thickness of the upper dielectric layer 104 being within a range of 30-60 nm.

Also, in U.S. Pat. No. 6,294,310, a phase change disk, having the same structure as illustrated in FIG. 1, is disclosed. The composition ratio of the recording layer 103 is Ge_{f}(Sb_{d}Te_{1-d})_{1-f}, with 0.65≦d≦0.85 and 0.01≦f≦0.20. The thickness of the recording layer 103 is within a range of 15-30 nm, with the thickness of the upper dielectric layer 104 being within a range of 10-50 nm and the thickness of the reflective layer 105 being within a range of 50-500 nm.

In the disk having the above structure, light (L) is incident from the lower portion of the substrate 101 and the light (L) is reflected by the recording layer 103 so that information recorded on the disk is reproduced.

However, in recent phase change optical disks, for high density recording, information is recorded and/or reproduced by using a pickup employing a laser diode (LD) emitting a laser beam of 400 nm wavelength and an objective lens having a high numeric aperture (NA) of about 0.85. In such recent phase change optical disks, an improved multi-layer film structure suitable for increased high density recording is required. Further, for the above high density recording, although a recording layer having the above eutectic composition is useful, the wavelength of the LD light source is very short, and an optical feature changes greatly depend on the thickness of each layer. Therefore, a composition, a composition ratio, and a range of thickness of each layer forming a multi-layer film suitable for the improved multi-layer film structure are needed.

### SUMMARY OF THE INVENTION

An object of the present invention is to provide a high density optical disk having a range of thickness of each layer constituting a multi-layer film, and thereby providing for superior recording/reproducing in the high density optical disk.

Additional objects and advantages of the invention will be set forth in part in the description which follows and, in part, will be obvious from the description, or may be learned by practice of the invention.

To achieve the above and other objects, an embodiment of the present invention includes a high density optical disk where a multi-layer film having at least one recording layer and a light transmission layer are deposited on a substrate. Information is recorded/reproduced by a light beam input from the upper portion of the light transmission layer, wherein a composition of the recording layer is Gex-Sby-Tez, and has a composition ratio such that 3≦x≦8, 65≦y≦80, and x+y+z=100.

An aspect of the present invention includes a high density optical disk where the multi-layer film is formed by depositing at least four layers including a reflective layer, a lower dielectric layer, a recording layer, and an upper dielectric layer on the substrate.

A further aspect of the present invention includes the high density optical disk where the recording film has a thickness of 10-20 nm.

Another aspect of the present invention includes the high density optical disk where the lower dielectric layer has a thickness of 10-30 nm.

An aspect of the present invention includes the high density optical disk where the upper dielectric layer has a thickness of 120-145 nm.

An aspect of the present invention includes the high density optical disk where the reflective layer has a thickness of 20-200 nm.

An aspect of the present invention includes the high density optical disk where the light transmission layer has a thickness of 150 μm or less.

An aspect of the present invention includes the high density optical disk where a protective layer is further provided on the light transmission layer.

An aspect of the present invention also includes the high density optical disk where the multi-layer film includes a reflective layer, a plurality of dielectric layers, a first recording layer, a separation layer, and a second recording layer, which are deposited on a substrate.

To achieve the above and other objects, in another embodiment of the present invention, a high density optical disk is provided with a multi-layer film having at least one recording layer and a light transmission layer deposited on a substrate, with a light beam being incident by passing through the light transmission layer, and with the recording layer having a thickness within a range of 10-20 nm.

### BRIEF DESCRIPTION OF THE DRAWINGS

These and other objects and advantages of the invention will become more apparent and more readily appreciated from the following description of the preferred embodiments, taken in conjunction with the accompanying drawings of which:

FIG. 1 illustrates a sectional view of a conventional optical disk;

FIG. 2 illustrates a sectional view of a high density optical disk according to an embodiment of the present invention;

FIG. 3 is a graph showing a change of C/N (dB) with respect to ΔR;

FIGS. 4 through 6 are graphs showing a result of a simulation where an optical feature standard is satisfactory with a changing of a thickness of a multi-layer film of a high density optical disk, according to an embodiment of the present invention;

FIG. 7 is a SEM photograph of a substrate used in a high density optical disk according to an embodiment of the present invention;

FIGS. 8A through 8E illustrate an RF signal and an EQ signal measured by changing a content of Sb in a recoding layer of a high density optical disk according to an embodiment of the present invention;

FIGS. 9A through 9E illustrate eye patterns measured while a content of Ge in a recording layer of a high density optical disk is changed according to an embodiment of the present invention;

FIG. 10 illustrates a sectional view of a high density optical disk according to another embodiment of the present invention;

FIG. 11 illustrates a structure of a system used for recording/reproduction of a high density optical disk according to another embodiment of the present invention;

FIGS. 12A-12E illustrate timing diagrams and show a recording pattern used during a recording of a high density optical disk according to another embodiment of the present invention;

FIGS. 13A, 13B, and 13C are graphs showing a change in recording power (Pw), erasure power (Pe), and a cooling power (Pc) according to the content of Sb in the recording layer, respectively;

FIGS. 14A, 14B, and 14C are graphs showing a change of Ttop, Tmp, and Tle according to the content of Sb in the recording layer, respectively; and

FIG. 15 is a view showing a change of a recording pattern according to the change in the content of Sb in the recording layer of the high density optical disk according to the present invention.

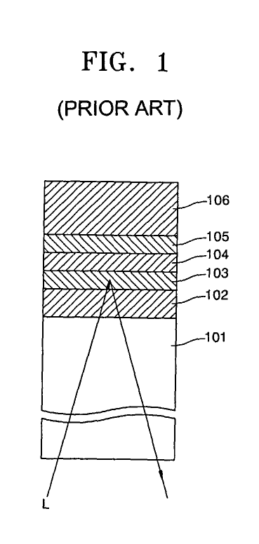

### DETAILED DESCRIPTION OF THE PREFERRED EMBODIMENTS

Reference will now made in detail to the present preferred embodiments of the present invention, examples of which are illustrated in the accompanying drawings, wherein like reference numerals refer to the like elements throughout. The embodiments are described below in order to explain the present invention by referring to the figures.

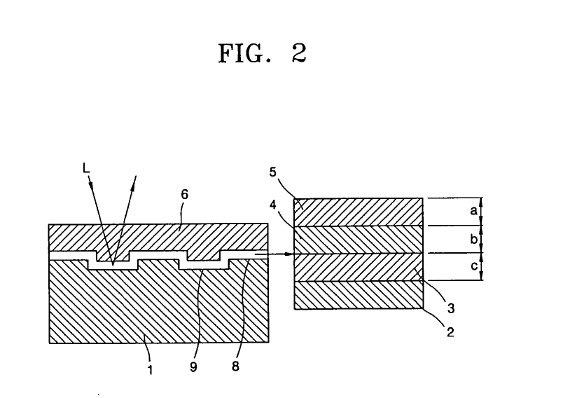

FIG. 2 illustrates a high density optical disk according to an embodiment of the present invention having a light transmission layer 6 and a multi-layer film having at least one recording layer deposited on a substrate 1. The multi-layer film can be formed by sequentially depositing at least four layers, including a reflective layer 2, a lower dielectric layer 3, a recording layer 4, and an upper dielectric layer 5. A groove 8 and a land 9 are formed on the substrate 1.

The substrate 1 for example, may be a polycarbonate substrate having a thickness of 1.1 mm. The reflective layer 2 is formed of one of Ag alloy, Au alloy, and Al alloy. Also, the lower and upper dielectric layers 3 and 5 can be formed of a ZnS-SiO₂ material. In the optical disk having the above structure, light L incident on the light transmission layer 6, from above, is reflected by the reflective layer 2 via the recording layer 4. The light transmission layer 6 may have a thickness of 0.2 mm or less, or preferably, 0.1 mm. In the high density optical disk according to this embodiment, information is recorded/reproduced by using an optical pickup including a laser diode having a short wavelength of 430 nm or less and an objective lens having a high numeric aperture (NA) of 0.7 or more.

It is necessary to have a suitable optical feature for a high density optical disk to exhibit a superior recording/reproduction characteristic. The optical feature can be set based on reflectivity. For example, the composition and composition ratio of the recording layer 4 and a range of the thickness of each layer may be determined to meet the following conditions.

Inequalities 1

(1) 0.15 < Rc < 0.30
(2) 0.03 < Ra < 0.10
(3) 0.12 < (Rc − Ra)

Here, Rc corresponds to the reflectivity of a disk when the recording layer 4 is crystalline, which relates to a case where information is erased. Although a high reflectivity is better when information is erased, when the reflectivity is excessively high, a recording sensitivity deteriorates. Thus, a reflectivity within an appropriate range is needed. The conditions of above Inequality 1-(1) correspond to those of a reflectivity of a typical DVD-RAM and DVD-RW.

In Inequality 1-(2), Ra corresponds to a reflectivity of a disk when the recording layer 4 is amorphous, which relates to a case where information is recorded. Ra must have a value slightly greater than 0 for focusing when the disk is initialized. When the value of the Ra is excessively high, the recording sensitivity deteriorates. Also, when the Ra belongs to the same range as that of the Rc, the state in which information is not recorded cannot be discriminated, so information is not accurately reproduced. Thus, the Ra is preferably set to have a range less than that of the Rc.

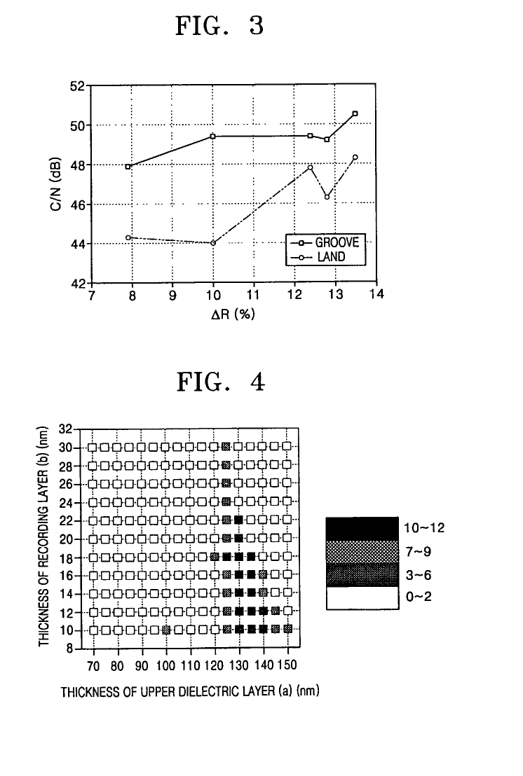

In Inequality 1-(3), (Rc−Ra) is a difference between the Rc and the Ra. As the difference increases, a carrier level of a recording signal increases. The minimum value 0.12 in Inequality 1-(3) corresponds to a condition for C/N (carrier/noise) of a 3T signal being 45 dB or more, both in the groove and land, during a performance test of the disk. The graph in FIG. 3 shows the result of measuring a change of C/N with respect to a reflectivity difference ΔR for each of the groove 8 and the land 9. According to the graph, it is appropriate that a reflectivity difference, where C/N satisfies 45 dB or more with respect to both groove and land, be 0.12. In the graph, the reflectivity difference is represented by percentage.

To obtain a range of the thickness of each layer satisfying the optical feature standard, e.g., any DVD optical feature standard, a multiple interference optical simulation has been performed with respect to a four-layer film disk shown in FIG. 2. The wavelength of a laser diode (LD) used in the simulation is 405 nm and a refractive index and a range of a change in the thickness of each layer are shown below. Here, the refractive index is set forth in a complex refractive index.

TABLE 1

| | | Range |
|---|---|---|
| | | of change |
| Material | Refractive index | of thickness |
| Light transmission layer and | 1.55 + 0i | |
| Substrate | | |
| Upper dielectric layer (ZnS— | 2.32 + 0i | 70-150 nm, |
| SiO₂) | | changing at an |
| | | interval |
| | | of 5 nm |
| Recording layer (Gex-Sby- | 2.90 + 2.95i (amorphous) | 10-30 nm, |
| Tez) | 1.65 + 3.15i (crystalline) | changing at an |
| | | interval |
| | | of 2 nm |
| Lower dielectric layer (ZnS— | 2.32 + 0i | 10-30 nm, |
| SiO₂) | | changing at an |
| | | interval |
| | | of 2 nm |
| Reflective layer (Ag alloy) | 0.75 + 3.87i | Fixed at 50 nm |

The following Tables 2, 3, 4 and 5 correspond to summaries of the number of each layer satisfying a predetermined optical feature standard when the thickness of the upper dielectric layer 5, the recording layer 4, and the lower dielectric layer 3 are changed within a range of a change of the thickness, as shown in Table 1. The case where a number satisfying the optical feature standard is one or two, is excluded from the manufacture of the disk, compared to the case where the number is three or more. In detail, Table 2 shows a result of measurements of a number of the lower dielectric layer 3 satisfying the preset optical feature standard, as a thickness of the upper dielectric layer 5 and the recording layer 4 are changed. In the following tables, a denotes a thickness of the upper dielectric layer 5, in nanometers (nm), b denotes a thickness of the recording layer 4, in nanometers (nm), and c denotes a thickness of the lower dielectric layer 3, in nanometers (nm).

TABLE 2

| | c | | | | | | | | | | |
|---|---|---|---|---|---|---|---|---|---|---|---|
| a | 10 | 12 | 14 | 16 | 18 | 20 | 22 | 24 | 26 | 28 | 30 |
| 70 | 1 | | | | | | | | | | |
| 75 | 1 | | | | | | | | | | |
| 90 | 1 | | | | | | | | | | |
| 95 | 2 | | | | | | | | | | |
| 100 | 3 | 2 | | | | | | | | | |
| 105 | 2 | 1 | | | | | | | | | |
| 110 | 1 | 1 | 1 | | | | | | | | |
| 115 | | | 1 | 1 | | | | | | | |
| 120 | 2 | 1 | 1 | 2 | 3 | 2 | 1 | 1 | | | |
| 125 | 4 | 3 | 3 | 4 | 6 | 5 | 5 | 4 | 4 | 4 | 3 |
| 130 | 6 | 6 | 6 | 7 | 9 | 9 | 8 | 6 | | | |
| 135 | 6 | 7 | 9 | 8 | 6 | | | | | | |
| 140 | 6 | 8 | 5 | 3 | | | | | | | |
| 145 | 5 | 4 | 2 | | | | | | | | |
| 150 | 4 | 2 | | | | | | | | | |

In the above Table 2, a simulation step is described when the thickness of the upper dielectric layer 5 is 130 nm and the thickness of the recording layer 4 is 10 nm. In the above conditions, when the thickness of the lower dielectric layer 3 is changed at the interval of 2 nm, within a range of 10-30 nm, the number of cases satisfying a predetermined optical feature standard is measured. The data of the above simulation is shown below in Table 3. Here, the number of cases satisfying the optical feature condition of Inequalities 1 is 6.

TABLE 3

| a (nm) | b (nm) | c (nm) | Rc (%) | Ra (%) | Rc − Ra (%) | Optical feature standard |
|---|---|---|---|---|---|---|
| 130 | 10 | 10 | 29.71 | 10.37 | 19.33 | Not satisfactory |
| 130 | 10 | 12 | 28.03 | 8.95 | 19.07 | Satisfactory |
| 130 | 10 | 14 | 26.4 | 7.67 | 18.73 | Satisfactory |
| 130 | 10 | 16 | 24.81 | 6.52 | 18.29 | Satisfactory |
| 130 | 10 | 18 | 23.26 | 5.47 | 17.78 | Satisfactory |
| 130 | 10 | 20 | 21.78 | 4.53 | 17.2 | Satisfactory |
| 130 | 10 | 22 | 20.23 | 3.68 | 16.54 | Satisfactory |
| 130 | 10 | 24 | 18.74 | 2.93 | 15.81 | Not satisfactory |
| 130 | 10 | 26 | 17.26 | 2.26 | 15 | Not satisfactory |
| 130 | 10 | 28 | 15.78 | 1.68 | 14.1 | Not satisfactory |
| 130 | 10 | 30 | 14.31 | 1.19 | 13.12 | Not satisfactory |

Every case where the thickness of the upper dielectric layer 5, the recording layer 4, and the lower dielectric layer 3 can be changed has been simulated in the above step. The shaded portion of Table 2 is an effective range satisfying the optical feature standard. The effective range is similarly illustrated in Tables 4 and 5.

FIG. 4 shows the result of Table 2. In FIG. 4, when the thickness of the upper dielectric layer 5 is within a range of 120-150 nm, and the thickness of the recording layer 4 is within a range of 10-30 nm, the optical feature standard is satisfied.

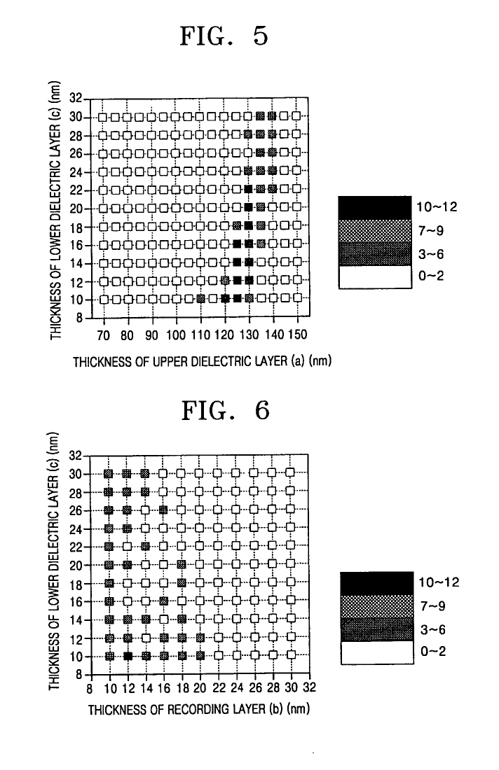

The results of a measurement of the recording layer 4 numbers satisfying the optical feature standard, when the thickness a of the upper dielectric layer 5 and the thickness c of the lower dielectric layer 3 are changed, are shown below in Table 4. Also, the results are also shown in the graph of FIG. 5. According to the graph of FIG. 5, when the thickness of the upper dielectric layer 5 is within a range of 120-140 nm and the thickness of the lower dielectric layer 3 is within a range of 10-30 nm, a predetermined optical feature standard is satisfied.

TABLE 4

| | c | | | | | | | | | | |
|---|---|---|---|---|---|---|---|---|---|---|---|
| a | 10 | 12 | 14 | 16 | 18 | 20 | 22 | 24 | 26 | 28 | 30 |
| 70 | | | | | | | | | | | |
| 75 | | | | | | | | | | | |
| 90 | | | | | 1 | | | | | | |
| 95 | | | 1 | 1 | | | | | | | |
| 100 | 2 | 2 | 1 | | | | | | | | |
| 105 | 2 | 1 | | | | | | | | | |
| 110 | 3 | | | | | | | | | | |
| 115 | 2 | | | | | | | | | | |
| 120 | 8 | 4 | 1 | | | | | | | | |
| 125 | 11 | 11 | 11 | 8 | 3 | 1 | | | | | |
| 130 | 5 | 7 | 7 | 7 | 7 | 7 | 6 | 3 | 2 | 3 | 2 |
| 135 | | | 2 | 4 | 5 | 5 | 5 | 5 | 5 | 4 | 4 |
| 140 | | | | | | 2 | 3 | 3 | 4 | 3 | 3 |
| 145 | | | | | | | 1 | 2 | 2 | 2 | 2 |
| 150 | | | | | | | | 1 | 1 | | |

Table 5 shows the results of a measurement of the upper dielectric layer 5 numbers satisfying the optical feature standard when the thickness b of the recording layer 4 and the thickness c of the lower dielectric layer 3 are changed. The above results are also shown in the graph of FIG. 6. Referring to Table 4 and FIG. 6, the thickness of the recording layer 4, satisfying a predetermined optical feature standard, is within a range of 10-20 nm and the thickness of the lower dielectric layer 3 is within a range of 10-30 nm.

TABLE 5

| | c | | | | | | | | | | |
|---|---|---|---|---|---|---|---|---|---|---|---|
| a | 10 | 12 | 14 | 16 | 18 | 20 | 22 | 24 | 26 | 28 | 30 |
| 10 | 5 | 5 | 4 | 4 | 3 | 3 | 4 | 4 | 5 | 4 | 3 |
| 12 | 6 | 3 | 3 | 2 | 2 | 3 | 2 | 3 | 3 | 3 | 3 |
| 14 | 5 | 2 | 3 | 2 | 2 | 2 | 3 | 2 | 2 | 3 | 3 |
| 16 | 4 | 3 | 2 | 3 | 2 | 2 | 2 | 2 | 3 | 2 | 2 |
| 18 | 3 | 3 | 3 | 2 | 3 | 3 | 2 | 2 | 2 | 1 | |
| 20 | 3 | 3 | 2 | 2 | 2 | 1 | 1 | 1 | | | |
| 22 | 2 | 2 | 2 | 2 | 2 | 1 | 1 | | | | |
| 24 | 2 | 1 | 1 | 1 | | | | | | | |
| 26 | 1 | 1 | 1 | 1 | | | | | | | |
| 28 | 1 | 1 | 1 | 1 | | | | | | | |
| 30 | 1 | 1 | 1 | | | | | | | | |

In light of the results of the above simulations, the determined range of the thickness of each layer, satisfying a predetermined optical feature standard in common, is as follows.

TABLE 6

| | Range of |
|---|---|
| Type of layer | thickness satisfying optical feature (nm) |
| Upper dielectric layer (ZnS— | 120-145 |
| SiO₂) | |
| Recording layer (Gex-Sby- | 10-20 |
| Tez) | |
| Lower dielectric layer (ZnS— | 10-30 |
| SiO₂) | |
| Reflective layer (Ag alloy) | 20 nm or more |

Regarding reflective layer 2, when the thickness thereof is 20 nm or more, there is no substantial difference in the optical feature, and thus the thickness can be set to 20 nm or more. In particular, the thickness of the reflective layer 2 may preferably be within a range of 20-200 nm.

As a further embodiment of the present invention, the composition and composition ratio of the recording layer 4, for a disk having the following conditions, are described below.

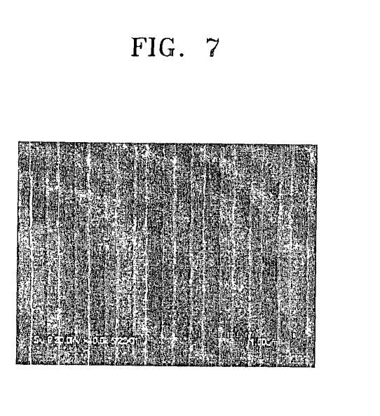

The substrate 1 used in this embodiment is formed of a polycarbonate material having a thickness of 1.1 mm, with the groove 8 and the land 9 being formed on the surface thereof. The depth and width of the groove 8 are 22.4 nm and 0.365 μm, respectively. FIG. 7 is a scanning electronic microscopy (SEM) photograph of the substrate 1.

A 30 nm thick Ag-Pb-Cu reflective layer, a 16 nm thick ZnS-SiO₂ lower dielectric layer, a 14 nm thick Ge-Sb-Te recording layer, and a 128 nm thick ZnS-SiO₂ upper dielectric layer, satisfying the optical feature standard, are sequentially deposited on the substrate 1. Here, the respective layers are deposited in a sputtering method, with the light transmission layer 6, having a thickness of 0.1 mm, being formed on the upper dielectric layer 5 in a spin coating method. Here, the disk having the above structure can be initialized by an initializing apparatus, and dynamic characteristics can be tested while changing the content of Sb in the composition of the recording layer 4. The conditions for a dynamic characteristics test include a wavelength of a laser diode being 405 nm, the NA of an objective lens being 0.85, linear velocity being 5.4 m/s, channel clock being 87 MHz, ten times of recording, code being EFM+, the minimum mark length being 0.185 μm, and with the data transmission velocity being 35 Mbps.

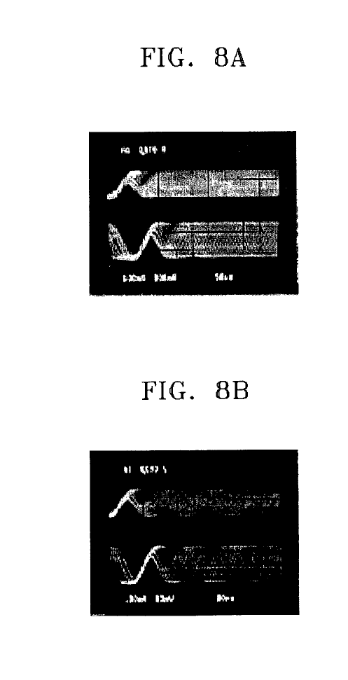

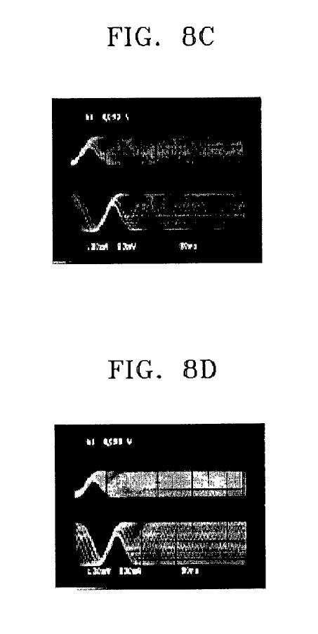

Under these circumstances, when the composition of the recording layer 4 is GexSbyTez, for example, by fixing the content (x) of Ge to 6 at.% and changing the content (y) of Sb within a range of 69-76 at.%, an RF signal and equalizing (EQ) signal are measured and the results thereof are shown in FIGS. 8A through 8E. In this case, both the RF signal and EQ signal are superior.

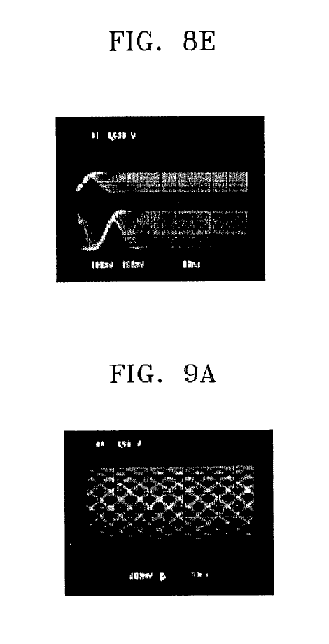

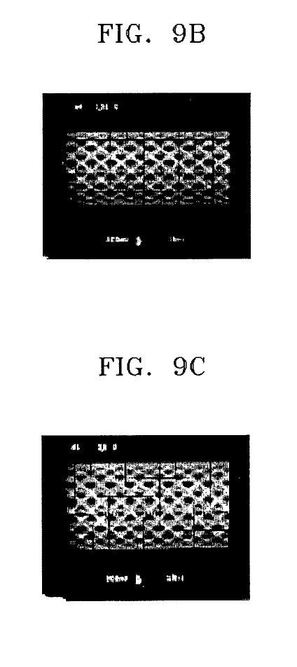

Also, when the composition of the recording layer 4 is GexSbyTez, for example, by fixing the content (y) of Sb to 72.5 at.% and changing the content (x) of Ge within a range of 3-8 at.%, an eye pattern is measured and the results thereof are shown in FIGS. 9A through 9E. In this case, all results exhibit superior features of having a jitter value around 10%.

Thus, the composition of the recording layer 4 is GexSbyTez and preferably has a composition ratio within ranges of 3≦x≦8, 65≦y≦80, and x+y+z=100.

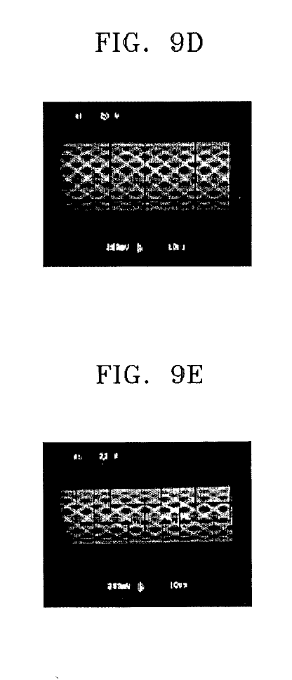

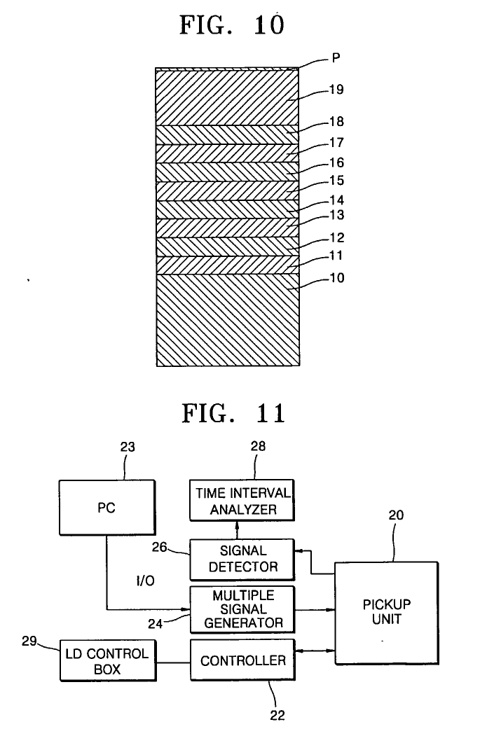

Furthermore, the above structure can be applied to a disk having multiple recording layers. For example, as shown in FIG. 10, the composition and composition ratio of the above-described recording layer can be applied to a disk including a substrate 10, a second reflective layer 11, a first dielectric layer 12, a second recording layer 13, a second dielectric layer 14, a separation layer 15, a third dielectric layer 16, a first recording layer 17, a fourth dielectric layer 18, and a light transmission layer 19. That is, the composition of the first and second recording layers 17 and 13 can be GexSbyTez, and preferably have a composition ratio such that 3≦x≦8, 65≦y≦80, and x+y+z=100. Although two recording layers are described, the above structure can be applied to a case of having two or more multiple recording layers. Here, a protective layer p for protecting a disk may be provided further on the light transmission layer 19. The protective layer p can be applied to the disk shown in FIG. 2.

In the meantime, a system used for recording/reproduction a high density optical disk according to the present invention is schematically shown in FIG. 11. In the recording/reproduction system illustrated in FIG. 11, when a disk is installed at a pickup unit 20, a controller 22 and an LD control box 29 control the linear velocity of the disk, recording power (Pw), erasure power (Pe), cooling power (Pc), and reproduction power (Pr). A pattern used for recording is determined through a PC 23 and a multiple signal generator 24. Here, the period of a recording pulse can be adjusted, when the disk is recorded as above, and the signal read out by the pickup unit 20 can be processed through a signal detector 26. Then, a time interval analyzer 28 analyzes jitter of a mark length.

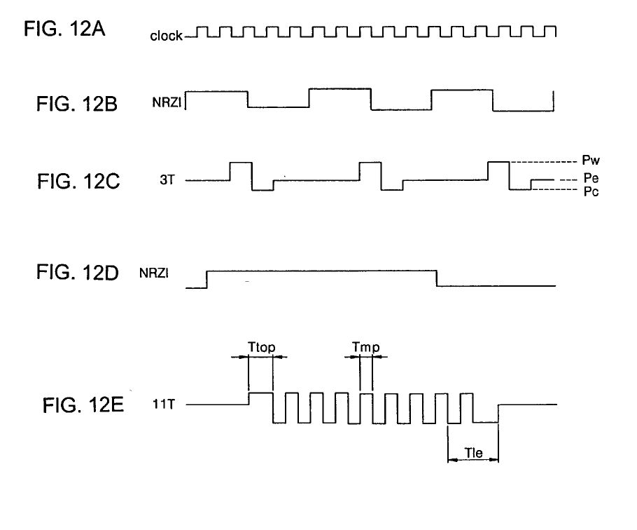

A recording pattern used when a high density optical disk embodiment of the present invention is recorded by the above system, is shown in FIGS. 12A-12E. A pattern having one peak level is used during recording of a 3T mark. A pulse having the recording power (Pw), the erasure power (Pe), and the cooling power (Pc) are applied. Also, a pattern having nine peak levels is used during recording of an 11T mark. A pulse applied at this time is shown in the drawing. Here, Ttop denotes a period of an initial pulse, Tmp denotes a period of a middle pulse, and Tle denotes a period of a last pulse. Here, a pattern having (n−2) number of peak levels is used during recording of an nT (n is 3 through 11 and 14) mark. However, a pattern having (n−1) number of peak levels can also be used.

Next, a test is performed to obtain an optimal recording condition for a recording layer of a composition according to an embodiment of the present invention. When the composition of the recording layer 4 is Gex-Sby-Tez, by fixing the content (x) of Ge to 6 at.% and changing the content (y) of Sb within a range between 69-76 at.%, a recording condition having an optimal jitter value can be sought.

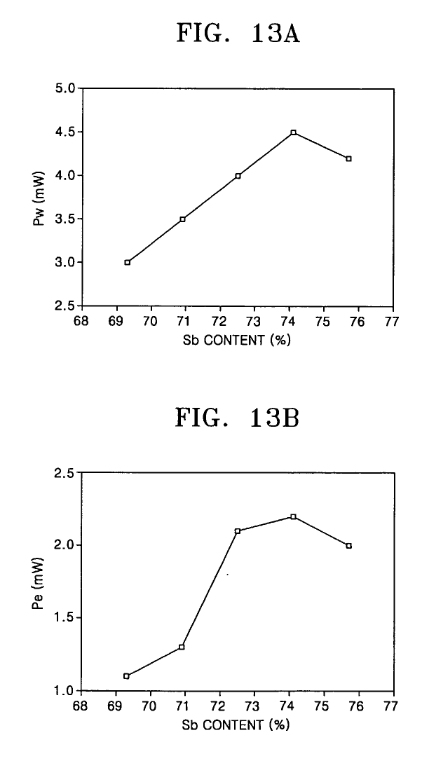

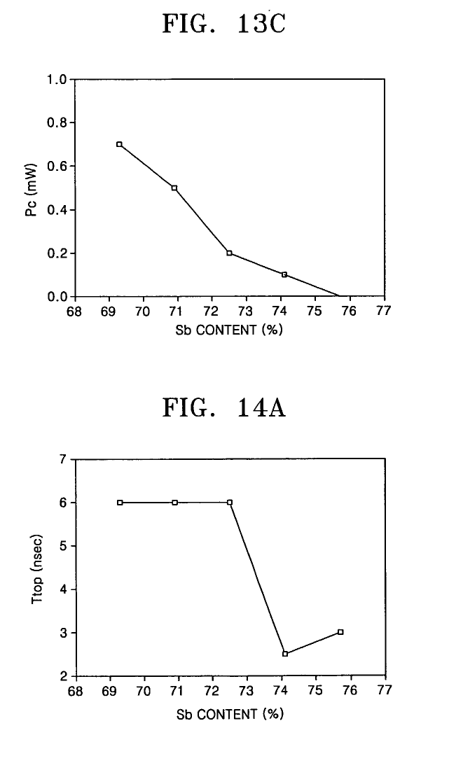

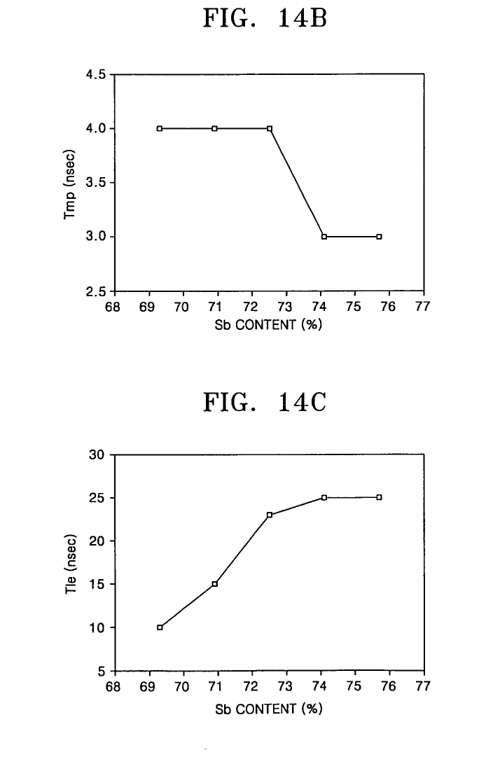

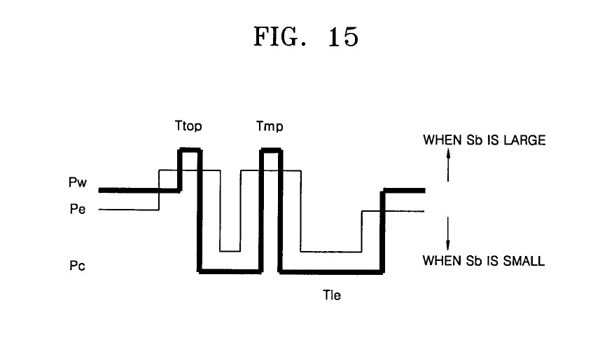

FIGS. 13A through 13C are related to power and FIGS. 14A through 14C are related to a pulse period.

FIG. 13A illustrates the result of obtainment of a recording power Pw having an optimal jitter value while the content (y) of Sb is changed. It can be seen that, as the content of Sb increases, the recording power Pw increases. FIG. 13B illustrates the result of obtainment of an erasure power Pe having an optimal jitter value, while the content (y) of Sb is changed. It can be seen that, as the content of Sb increases, the erasure power Pw increases. FIG. 13C illustrates the result of using a cooling power Pc having an optimal jitter value while the content (y) of Sb is changed. It can be seen that, as the content of Sb increases, the cooling power Pw decreases.

FIG. 14A illustrates an obtained period of an initial pulse Ttop having an optimal jitter value, while the content (y) of Sb is changed. It can be seen that Ttop hardly changes until the content of Sb increases to a certain degree, but finally decreases. FIG. 14B illustrates an obtained period of a middle pulse Tmp having an optimal jitter value while the content (y) of Sb is changed. It can be seen that Tmp changes similarly to Ttop. FIG. 14C illustrates an obtained period of a last pulse Tle, with Tle having an optimal jitter value while the content (y) of Sb is changed. It can be seen that, as the content of Sb increases, the period of a last pulse Tle increases.

According to the above test results, it can be seen that, as the content of Sb increases, since the speed of re-crystallization of the recording layer increases, the recording condition changes to delay the re-crystallization speed. The above result is roughly illustrated in the graph of FIG. 15. In the graph of FIG. 15, the thick line illustrates a change of the recording condition according to the change of the content (y) of Sb.

As described above, a range of a thickness and a composition ratio of each layer suitable for a high density optical disk having a multi-layer structure, and recording/reproduction conditions corresponding thereto, can be obtained.

In the high density optical disk according to embodiments of the present invention, the wavelength of a laser diode adopted in a pickup becomes shorter and, as the NA of an objective lens becomes high, each layer forming a multi-layer film needs a range of thickness and composition ratio to satisfy an optical feature suitable therefore. Thus, by satisfying the optical feature standards requested, as the density of recording capacity increases, an optical disk is provided that can obtain a superior signal characteristic during reproduction after information is recorded on the disk.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A high density optical disk, including a multi-layer film having at least one recording layer and a light transmission layer deposited on a substrate, such that information is recordable and/or reproducable by a light beam input from the upper portion of the light transmission layer, wherein
the recording layer includes a composition of Gex-sby-Tez, with a composition ratio such that: 3≦x≦8, 65≦y≦80, and x+y+z=100.

2. The high density optical disk of claim 1, wherein the multi-layer film comprises at least four layers, including a reflective layer, a lower dielectric layer, a recording layer, and an upper dielectric layer on the substrate.

3. The high density optical disk of claim 2, wherein the recording layer has a thickness of 10-20 nm.

4. The high density optical disk of claim 3, wherein the lower dielectric layer has a thickness of 10-30 nm.

5. The high density optical disk of claim 3, wherein the upper dielectric layer has a thickness of 120-145 nm.

6. The high density optical disk of claim 4, wherein the upper dielectric layer has a thickness of 120-145 nm.

7. The high density optical disk of claim 6, wherein the reflective layer has a thickness of 20-200 nm.

8. The high density optical disk of claim 7, wherein the light transmission layer has a thickness of 150 μm or less.

9. The high density optical disk of claim 8, further comprising a protective layer on the light transmission layer.

10. The high density optical disk of claim 6, further comprising a protective layer on the light transmission layer.

11. The high density optical disk of claim 5, further comprising a protective layer on the light transmission layer.

12. The high density optical disk of claim 3, further comprising a protective layer on the light transmission layer.

13. The high density optical disk of claim 2, wherein the lower dielectric layer has a thickness of 10-30 nm.

14. The high density optical disk of claim 2, wherein the upper dielectric layer has a thickness of 120-145 nm.

15. The high density optical disk of claim 1, wherein the multi-layer film includes a reflective layer, a plurality of dielectric layers, a first recording layer, a separation layer, and a second recording layer that are deposited on a substrate.

16. The high density optical disk of claim 1, wherein x is about 6 and y is in a range between 69 and 76.

17. The high density optical disk of claim 2, wherein the reflective layer includes one of Ag, Au alloy, and Al alloy

18. The high density optical disk of claim 2, where the lower and upper dielectric layer include a ZₙS-SiO₂ material.

19. A high density optical disk comprising a substrate with a deposited multi-layer film having at least one recording layer and a light transmission layer, such that a light beam incident on the light transmission layer passes through the light transmission layer, wherein the recording layer has a thickness within a range of 10-20 nm.

20. The high density optical disk of claim 19, wherein the multi-layer film is formed by depositing at least four layers, including a reflective layer, a lower dielectric layer, a recording layer, and an upper dielectric layer, on the substrate.

21. The high density optical disk of claim 20, wherein the lower dielectric layer has a thickness of 10-30 nm.

22. The high density optical disk of claim 20, wherein the upper dielectric layer has a thickness of 120-145 nm.

23. The high density optical disk of claim 20, wherein the reflective layer has a thickness of 20-200 nm.

24. The high density optical disk of claim 19, wherein the light transmission layer has a thickness of 150 μm or less.

25. The high density optical disk of claim 19, further comprising a protective layer on the light transmission layer.

26. The high density optical disk of claim 21, wherein the upper dielectric layer has a thickness of 120-145 nm.

27. The high density optical disk of claim 26, wherein the reflective layer has a thickness of 20-200 nm.

28. The high density optical disk of claim 27, wherein the light transmission layer has a thickness of 150 μm or less.

29. The high density optical disk of claim 19, wherein the high density optical disk includes lands and grooves.

30. The high density optical disk of claim 19, wherein the light beam has a wavelength of 430 nm or less.

31. The high density optical disk of claim 19, wherein a reflectivity of a portion of the high density optical disk is between 0.15 and 0.3, when a corresponding portion of the recording layer is crystalline.

32. The high density optical disk of claim 19 wherein a reflectivity of a portion of the high density optical disk is between 0.03 and 0.1 when a corresponding portion of the recording layer is amorphous.

33. The high density optical disk of claim 19, wherein the difference between a reflectivity of portion of the recording layer where the portion is crystalline and a reflectivity of a portion of the recording layer where the portion is amorphous is greater than 0.12.

34. An optical disk recording/reproduction apparatus, comprising:
a pickup unit to radiate a light beam to a high density optical disk, through a light transmission layer and onto a recording layer having a thickness within the range of 10-20 nm; and
a controller to control the recording/reproduction of information to/from, respectively, the high density optical disk.

35. The optical disk recording/reproduction apparatus of claim 34, wherein the multi-layer film of the high density optical disk includes at least four deposited layers, including a reflective layer, a lower dielectric layer, a recording layer, and an upper dielectric layer, on the substrate.

36. The optical disk recording/reproduction apparatus of claim 35, wherein the lower dielectric layer has a thickness of 10-30 nm.

37. The optical disk recording/reproduction apparatus of claim 35, wherein the upper dielectric layer has a thickness of 120-145 nm.

38. The optical disk recording/reproduction apparatus of claim 35, wherein the reflective layer has a thickness of 20-200 nm.

39. The optical disk recording/reproduction apparatus of claim 34, wherein the light transmission layer has a thickness of 150 μm or less.

40. The optical disk recording/reproduction apparatus of claim 34, wherein the high density optical disk includes a protective layer provided on the light transmission layer.

41. The optical disk recording/reproduction apparatus of claim 36, wherein the upper dielectric layer has a thickness of 120-145 nm.

42. The optical disk recording/reproduction apparatus of claim 41, wherein the reflective layer has a thickness of 20-200 nm.

43. The optical disk recording/reproduction apparatus of claim 42, wherein the light transmission layer has a thickness of 150 μm or less.

44. The optical disk recording/reproduction apparatus of claim 34, wherein the high density optical disk includes lands and grooves.

45. The optical disk recording/reproduction apparatus of claim 34, wherein the pickup unit includes a diode for emitting a light beam having a wavelength of 430 nm or less.

46. The optical disk recording/reproduction apparatus of claim 34, wherein a reflectivity of a portion of the high density optical disk is between 0.15 and 0.3, when a corresponding portion of the recording layer is crystalline.

47. The optical disk recording/reproduction apparatus of claim 34, wherein a reflectivity of a portion of the high density optical disk is between 0.03 and 0.1, when a corresponding portion of the recording layer is amorphous.

48. The optical disk recording/reproduction apparatus of claim 34, wherein the difference between a reflectivity of portion of the recording layer where the portion is crystalline and a reflectivity of a portion of the recording layer where the portion is amorphous is greater than 0.12.
